(19) United States
(12) Patent Application Publication
(10) Pub. No.: US 2010/0062806 A1
(43) Pub. Date: Mar. 11, 2010

(54) APPARATUS FOR ESTABLISHING COMMUNICATIONAL ENVIRONMENT TO BE CONNECTED WITH A MOBILE PHONE AND METHOD USING THE SAME

(75) Inventor: Dug Hwan Han, Gyeinggi-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: STARCHIP Ltd., Gyeonggi-do (KR)

(21) Appl. No.: 12/306,487

(22) PCT Filed: Mar. 21, 2007
(86) PCT No.: PCT/KR2007/001380

§ 371 Date: Oct. 14, 2009

(30) Foreign Application Priority Data
Jun. 30, 2006 (KR) 10-2006-0060142

(51) Int. Cl. H04M 1/00

(52) U.S. Cl. 455/557

(57) ABSTRACT

The present invention relates to a communicational environment establishing apparatus to be connected to a mobile phone with integrated interfacing information built therein and a method for establishing an optimized communicational environment, when coupled to the mobile phone, by applying built-in integrated interfacing information, which is set variously according to mobile phones and their manufacturers; recognizing the manufacturer, the model name, the operating/communicational environments and the version number of a mobile phone; and thus optimizing the connection with a mobile phone. The communicational environment establishing apparatus comprises a power control module configured to communicate with the mobile phone when power is supplied to the apparatus, and a central control module for receiving hardware information from the mobile phone and matching its communicational environment to that of the mobile phone, wherein the central control module includes a communication device controller, an EEPROM, and an RAM.

### TECHNICAL FIELD

The present invention relates, in general, to a communicational environment establishing apparatus to be connected to a mobile phone with integrated interfacing information built therein and a method for establishing the same. More particularly, the present invention relates to a communicational environment establishing apparatus and the method which can optimize a communicational environment, when coupled to the mobile phone, by applying built-in integrated interfacing information, which is set variously according to mobile phones and their manufacturers, such as a data Input/Output method, a power supplying method, and a device control method; recognizing a manufacturer, a model name, operating/communicational environments and a version number of a mobile phone; and thus optimizing the connection with a mobile phone.

### BACKGROUND ART

In general, portable wireless devices such as mobile phones, provide a variety of supplementary services as well as voice call, and have advanced to multimedia devices capable of executing multimedia contents. Thus, functionality of the wireless data communication therein has gradually expanded.

In wireless data communication through mobile phones, various data of multimedia contents, such as video and voice as well as texts and images, can be transmitted and received wirelessly.

That is, a variety of supplementary services, which were available on a wired network, can be executed even in the mobile phones.

In the prior art, in order for multimedia contents to be executed in the mobile phones, a mobile phone should be connected to a multimedia contents server networked for a wireless data communication, and then one searches for the multimedia contents, and executes them after downloading them or by streaming service.

Thus, in the case where the multimedia contents are received through the streaming service, there is a problem in that an access cost consistently occurs during the time where the mobile phone is connected to the wireless data communication network. In the case where the multimedia contents are downloaded, there is a problem in that a menu consisting of several steps has to be executed in order to play stored multimedia contents. That is, the mobile phone must be connected to the wireless data communication network in order to download the multimedia contents, and then operating steps set in the mobile phone must be performed in order to execute the downloaded multimedia contents.

Furthermore, multimedia contents through the conventional wireless data communication have different file formats depending on a manufacturing company, a model name, operating environment and a version number of a mobile phone, or a mobile communication service company. Accordingly, there is a problem in that downloading and playback of multimedia contents are impossible when mobile handset manufacturing companies or mobile communication service companies differ.

### DISCLOSURE OF INVENTION

### Technical Problem

Accordingly, the present invention has been made keeping in mind the above problems occurring in the prior art, and an object of the present invention is to provide a communicational environment establishing apparatus with integrated interfacing information built therein, in which data can be provided to mobile phones through the communicational environment establishing apparatus by connecting to the mobile phone, thus enabling data communication with any mobile phones, regardless of difference of a mobile handset manufacturing company, a model name, communicational environment, operating environment and a version number of a mobile phone, or a mobile communication service company.

Another object of the present invention is to provide a data providing method of a communicational environment establishing apparatus with integrated interfacing information built therein, which is connected to a mobile phone capable of executing multimedia contents stored in a storage module without accessing a wireless data communication network.

### Technical Solution

To achieve the above objects, according to the present invention, there is provided a communicational environment establishing apparatus to be coupled to a mobile phone with integrated interfacing information built therein, comprises a power control module configured to communicate with the mobile phone when power is supplied to the communicational environment establishing apparatus by being coupled to the mobile phone, and a central control module for receiving hardware information from the mobile phone and matching a communicational environment of the communicational environment establishing apparatus to that of the mobile phone. The central control module includes a communication device controller for transmitting data based on communicational environment information set in accordance with the hardware information of the mobile phone, an EEPROM for storing an instruction to request the hardware information of the mobile phone and the communicational environment information, and an RAM for storing interfacing information corresponding to the hardware information of the mobile phone.

### ADVANTAGEOUS EFFECTS

Accordingly, in providing multimedia contents stored in a communicational environment establishing apparatus by coupling the apparatus to a mobile phone in accordance with the present invention, the communicational environment establishing apparatus has integrated interfacing information, such as a mobile handset manufacturing company, a model name, a version number and a communicational environment of a mobile phone built therein. Thus, although the communicational environment establishing apparatus is coupled to different types of mobile phones, a communicational environment of the apparatus of the present invention can be established suitably for that of the mobile phones. Accordingly, there is an advantage in that the present invention can achieve high compatibility in establishing a communicational environment in mobile phones.

Furthermore, the communicational environment establishing apparatus can execute multimedia contents even without accessing to a wireless data communication network or utilizing a streaming service. Accordingly, there are advantages in that expenses occurring when gaining access to a wireless data communication network can be saved and multimedia contents can be executed even in places where communication is impossible.

### BRIEF DESCRIPTION OF THE DRAWINGS

FIG. 1 is a perspective view of a communicational environment establishing apparatus used in a mobile phone according to the present invention;

FIG. 2 is a block diagram of the communicational environment establishing apparatus according to the present invention;

FIG. 3 is a flowchart illustrating a method of establishing a communicational environment according to the present invention; and

FIG. 4 is a flowchart illustrating a method of providing multimedia contents according to the present invention.

### DESCRIPTION ON REFERENCE NUMERALS

100: mobile phone 150: USB port
200: communicational environment establishing apparatus 205: USB interface module
210: power control module 215: interface controller
220: power supply controller 225: central control module
230: communication device controller 235: main controller
240: storage controller 245: EEPROM
250: RAM 255: storage module

### MODE FOR THE INVENTION

The present invention will now be described in detail in connection with specific embodiments with reference to the accompanying drawings.

It is to be understood that the terminology and phraseology employed herein are for the purpose of description and are not to be construed as limiting. They are, thus, best understood when interpreted in the context of the technological concept and scope of the present invention.

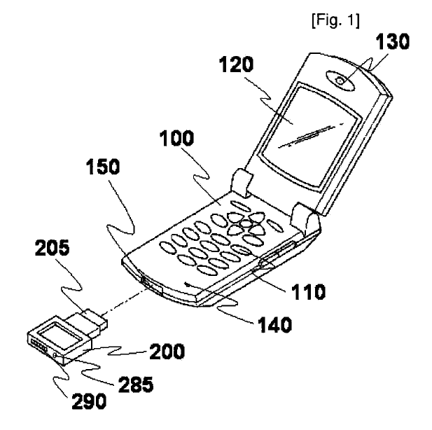

FIG. 1 is a perspective view of a communicational environment establishing apparatus used in a mobile phone according to the present invention. A general mobile phone 100 includes, as shown in FIG. 1, a plurality of buttons 110, a display unit 120 on which data processed at a mobile phone 100 is displayed, a speaker 130 from which voice data is outputted, and a microphone 140 for voice inputting. The mobile phone 100 further includes a USB port 150 for inputting/outputting data through the mobile phone.

A communicational environment establishing apparatus 200 according to the present invention includes a USB interface module 205 that is to be coupled to the USB port 150 of the mobile phone 100, and can be coupled to the USB port 150 of the mobile phone 100, if appropriate.

The communicational environment establishing apparatus 200 is supplied with electric power from one of a dedicated battery (not shown), a mobile phone 100, and a power supply unit 285. The dedicated battery (not shown) is included in the communicational environment establishing apparatus 200. The electric power of the mobile phone 100 can also be utilized as a power source of the communicational environment establishing apparatus 200. Further, the communicational environment establishing apparatus 200 can use an external power source through the power supply unit 285.

A storage interface module 290 for storing, modifying or deleting multimedia contents can be disposed on one side of the communicational environment establishing apparatus 200.

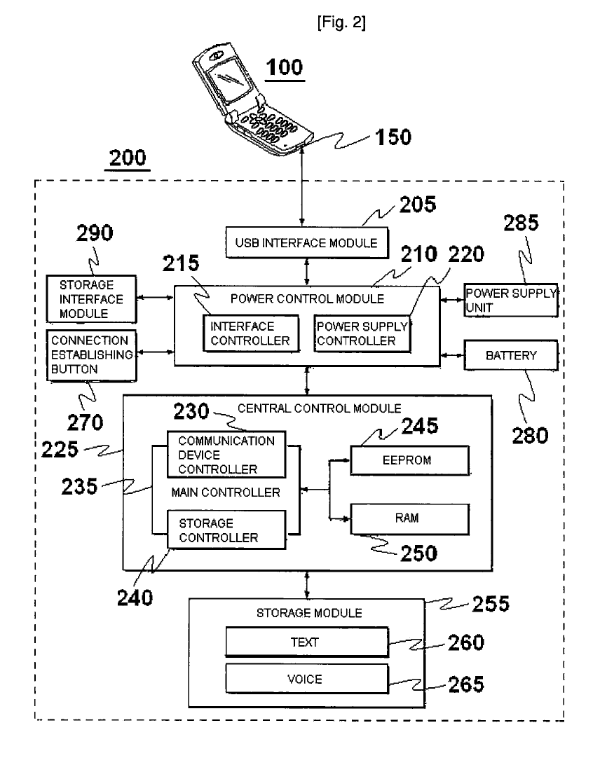

FIG. 2 is a block diagram of the communicational environment establishing apparatus according to the present invention. The communicational environment establishing apparatus 200 includes, as shown in FIG. 2, the USB interface module 205 to be coupled to the USB port 150 of the mobile phone 100. The USB interface module 205 is connected to a power control module 210. The power control module 210 includes an interface controller 215 and a power supply controller 220.

The power supply controller 220, when the USB interface module 205 of the communicational environment establishing apparatus 200 is coupled to the USB port 150 of the mobile phone 100, senses an electric power source inputted therein and allows the power source to be used in the communicational environment establishing apparatus 200. The electric power for the communicational environment establishing apparatus 200 can be supplied from a battery 280 included within the communicational environment establishing apparatus 200 or from an external power source through the power supply unit 285 of the communicational environment establishing apparatus 200. Alternatively, the power source to the communicational environment establishment apparatus 200 can include the power source of the mobile phone 100 electrically connected to the communicational environment establishing apparatus 200. The mobile phone 100 has a different power source depending on every manufacturing company and model. The power source used in the communicational environment establishing apparatus 200 also differs from that of the mobile phone 100. Thus, when the power source of the mobile phone 100 is used as that of the communicational environment establishing apparatus 200, the power supply controller 220 senses the power source of the mobile phone 100 and transforms the power source so as to be available in the communicational environment establishing apparatus 200.

The interface controller 215 serves to control the USB interface module 205 of the communicational environment establishing apparatus 200. When the USB interface module 205 is coupled to the USB port 150 of the mobile phone 100 and has electric power supplied from the mobile phone 100, the interface controller 215 serves to establish or terminate connection between the USB interface module 205 and the USB port 150 of the mobile phone 100.

If the interface controller 215 establishes connection between the communicational environment establishing apparatus 200 and the mobile phone 100, the communicational environment establishing apparatus 200 establishes communication connection for data transmission with the mobile phone 100. A central control module 225 includes a main controller 235, a communication device controller 230, a storage controller 240, EEPROM 245, and RAM 250.

The main controller 235 serves to control each constituent element of the central control module 225. The main controller 235 can output or input data from or to the EEPROM 245 or the RAM 250 as well as manage the communication device controller 230 and the storage controller 240.

The EEPROM 245 stores an instruction to request hardware information including a mobile handset manufacturing company, a model name, a version number and a communication method of the mobile phone 100, and a communication method information corresponding to each hardware information received from the mobile phone 100.

The RAM 250 stores integrated interfacing information such as a mobile handset manufacturing company, a model name, a version number and a communication method of the mobile phone 100. The RAM 250 also stores interfacing information corresponding to hardware information received from the mobile phone 100 in the EEPROM 245 and establishes communication with the mobile phone 100. In addition, the RAM 250 stores an instruction to automatically execute an application program for playing multimedia contents in the mobile phone.

The integrated interfacing information integrally includes the size of transmission data and related information such as the type of a communication protocol, the data transmission speed, the data buffer size and the like which are various depending on hardware information of the mobile phone 100. After interfacing information corresponding to the hardware information of the mobile phone 100 is loaded onto the EEPROM 245, communication between the communicational environment establishing apparatus 200 and the mobile phone 100 is initiated.

The communication device controller 230 serves to establish communication connection between the communicational environment establishing apparatus 200 and the mobile phone 100 and control data transmission/reception. The communication device controller 230 sends a request signal to request hardware information of the mobile phone 100 with an instruction stored in the EEPROM 245, and stores corresponding interfacing information stored in the RAM 250 when the hardware information is received from the mobile phone 100.

The storage controller 240 serves to control a storage module 255. When the storage controller 240 is requested for transmission of stored data by the mobile phone 100, it reads data stored in the storage module 255 and sends the read data in response to an instruction signal from the main controller 235. In this case, the size, type, and the like of the data transmitted through the storage controller 240 are processed so as to be transmitted at once based on the communication interface information of the mobile phone 100.

The storage module 255 stores multimedia contents such as texts 260, voice 265, images, motion images according to their types. The storage module 255 can be included within the communicational environment establishing apparatus 200 or disposed outside the communicational environment establishing apparatus 200.

Besides, a connection establishing button 270 is externally disposed on one side of the communicational environment establishing apparatus 200. The connection establishing button 270 can electrically connect or disconnect the USB interface module 205, even when the communicational environment establishing apparatus 200 is electrically connected to the mobile phone 100, by being connected to the interface controller 215 of the power control module 210.

In this case, the interface controller 215 can establish or terminate the connection between the mobile phone 100 and the communicational environment establishing apparatus 200 in response to an external signal received from the connection establishing button 270.

The integrated interfacing information stored in the RAM 250 and the multimedia contents, that is, the data stored in the storage module 255 can be stored, modified or deleted through a storage interface module 290 of the communicational environment establishing apparatus 200. Thus, if it is sought to update communicational environment information of the mobile phone 100 or to modify or delete the data stored in the storage module, the information or data can be updated, modified or deleted through the storage interface module 290.

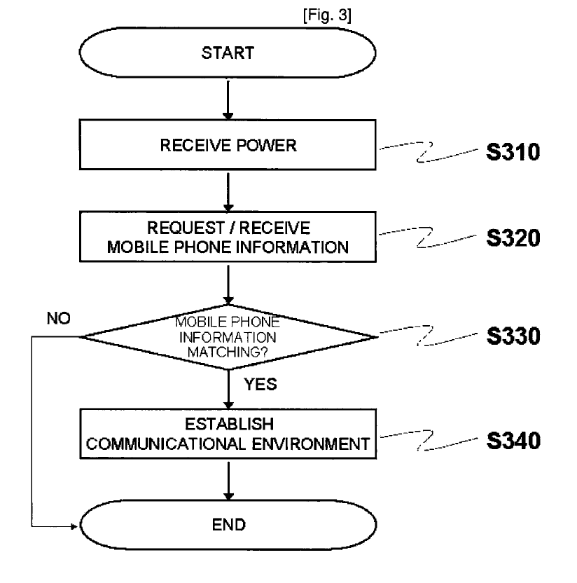

FIG. 3 is a flowchart illustrating a method of establishing a communicational environment according to the present invention. Referring to FIG. 3, in the case where the communicational environment establishing apparatus is coupled to the USB port of the mobile phone, the power supply controller of the power control module receives electric power from the mobile phone, converts the power into a kind available for driving the communicational environment establishing apparatus, and provides the converted power, or receives electric power from the dedicated battery within the communicational environment establishing apparatus or through the power supply unit of the communicational environment establishing apparatus and supplies the received power to the communicational environment establishing apparatus (S310).

If the power is supplied to the communicational environment establishing apparatus, the main controller sends an instruction stored in the EEPROM to request hardware information of the mobile phone to the communication device controller. Then the communication device controller sends the instruction to the mobile phone.

After the main controller receives hardware information such as a mobile handset manufacturing company, a model name, a version number, a communication method and so forth from the mobile phone (S320), it compares the received hardware information with integrated interfacing information stored in the RAM (S330).

If there is interfacing information corresponding to the received hardware information of the mobile phone, the corresponding interfacing information stored in the RAM is stored in the EEPROM and the communicational environment with the mobile phone is established (S340).

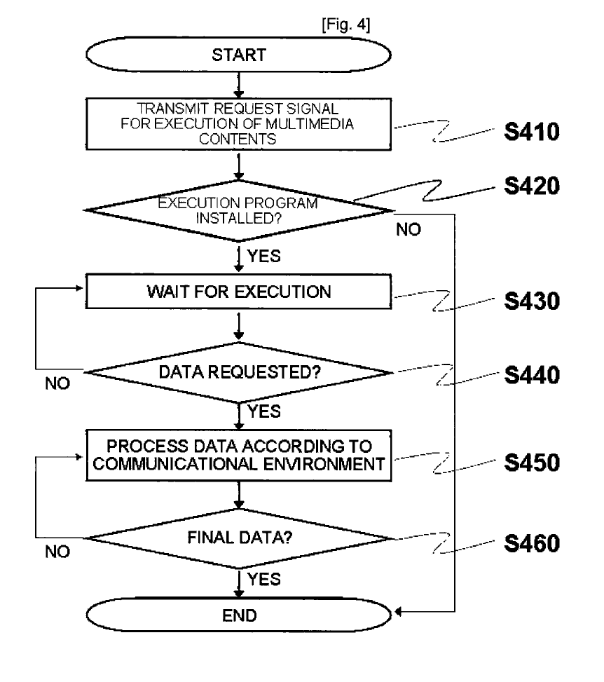

FIG. 4 is a flowchart illustrating a method of providing stored data according to the present invention. Referring to FIG. 4, if a request signal to request transmission of stored data is received from the mobile phone (S410), the central control module of the communicational environment establishing apparatus sends a signal to the mobile phone so as to check whether an application program for executing data has been installed in the mobile phone, and receives from the mobile phone in response thereto a signal to indicate whether the application program has been installed or not (S420).

If the signal indicates that the application program has been installed in the mobile phone, the communicational environment establishing apparatus waits for execution until it receives a request signal to request transmission of data for data execution (S430).

Thereafter, if the request signal for data execution is received from the mobile phone (S440), the storage controller of the central control module processes data stored in the storage module according to interfacing information set suitable for the communicational environment of the mobile phone, and sends the processed data to the mobile phone (S450). The mobile phone executes the received data.

It is checked whether the received data is the final data (S460). If it is indicated that the received data is the final data, the processing of multimedia contents data according to the available communicational environment is finished. If it indicates that the received data is not the final data, subsequent data in the stored data is continuously processed (S450).

Although the specific embodiments of the present invention have been disclosed for illustrative purposes, those skilled in the art will appreciate that various modifications, additions and substitutions are possible, without departing from the scope and spirit of the invention as disclosed in the accompanying claims.

1. A communicational environment establishing apparatus to be connected to a mobile phone with integrated interfacing information built therein, comprising:
a power control module configured to communicate with the mobile phone when power is supplied to the communicational environment establishing apparatus by being coupled to the mobile phone; and
a central control module for receiving hardware information from the mobile phone and matching the communicational environment of the communicational environment establishing apparatus to that of the mobile phone,
wherein the central control module includes:
a communication device controller for transmitting data based on communicational environment information set in accordance with the hardware information of the mobile phone;
an EEPROM for storing an instruction to request the hardware information of the mobile phone and the communicational environment information; and
an RAM for storing interfacing information corresponding to the hardware information of the mobile phone.

2. The communicational environment establishing apparatus of claim 1, wherein the hardware information includes one or more of a manufacturing company, a model name, a model version number and a communicational environment of the mobile phone.

3. The communicational environment establishing apparatus of claim 1, wherein the interfacing information includes one or more of a communication protocol type, a communication speed and a size of data to be transmitted or received depending on the hardware information of the mobile phone.

4. The communicational environment establishing apparatus of claim 3, wherein the interfacing information can be upgraded.

5. The communicational environment establishing apparatus of claim 1, wherein the power control module comprises:
an interface controller for controlling connection to the mobile phone; and
a power supply controller for being supplied with power.

6. The communicational environment establishing apparatus of claim 5, wherein the interface controller electrically connects the communicational environment establishing apparatus to the mobile phone when the power supply controller begins supplying power.

7. The communicational environment establishing apparatus of claim 5, wherein the interface controller terminates electrical connection between the communicational environment establishing apparatus and the mobile phone when the power supply controller stops supplying power.

8. The communicational environment establishing apparatus of claim 5, wherein the interface controller establishes or terminates electrical connection between the communicational environment establishing apparatus and the mobile phone in response to an externally inputted signal.

9. The communicational environment establishing apparatus of claim 5, wherein the power supply controller is supplied with power from one of the mobile phone, a battery equipped in the communicational environment establishing apparatus, and a power supply unit connected to the communicational environment establishing apparatus.

10. The communicational environment establishing apparatus of claim 1, further comprising:
a storage module for storing data to be provided to the mobile phone;
a connection establishing button for sending, to the power control module, a signal to control connection, the signal capable of activating or terminating the connection even when the communicational environment establishing apparatus and the mobile phone are coupled; and
a storage interface module for providing an interface capable of storing, modifying or deleting said data.

11. The communicational environment establishing apparatus of claim 1 or 10, wherein the central control module further comprises a storage controller for controlling an input/output of the data stored in the storage module.

12. The communicational environment establishing apparatus of claim 11, wherein the storage module can be equipped therein or externally provided thereto.

13. A method for establishing a communicational environment between a communicational environment establishing apparatus and a mobile phone by employing integrated interfacing information, the method comprising:
a first step of being supplied with power by being electrically connected to the mobile phone;
a second step of sending a request signal to request hardware information of the mobile phone;
a third step of receiving the hardware information from the mobile phone;
a fourth step of comparing the hardware information and interfacing information stored in RAM; and
a fifth step of setting communicational environment information based on interfacing information corresponding to the hardware information and storing the set communicational environment information in EEPROM.

14. The method of claim 13, wherein in the first step, when the communicational environment establishing apparatus is coupled to the mobile phone, the communicational environment establishing apparatus makes use of the power supplied from the mobile phone through a power supply controller.

15. A method for providing data using the communicational environment establishing apparatus, wherein the data is stored in a storage module, the method comprising:
a first step of allowing a communicational environment establishing apparatus to send, to a mobile phone, a request signal to request execution of an application program for executing the data;
a second step of receiving, from the mobile phone, a response signal to the request signal;
a third step of waiting for execution when a signal indicating completion of executing the application program in the second step is received;
a fourth step of processing the data stored in the storage module suitable for a communicational environment set in EEPROM when a request signal to request transmission of the data is received from the mobile phone; and
a fifth step of sending, to the mobile phone, the data processed in the fourth step.

16. The method of claim 15, wherein the response signal of the second step is an executable signal including an application program for executing the data.

17. The method of claim 15, wherein the data of the fourth step can be changed in one or more of a transmission type and a transmission size in order to be transmitted according to communicational environment information set in the EEPROM.
